(19) United States
(12) Patent Application Publication
(10) Pub. No.: US 2007/0209846 A1
(43) Pub. Date: Sep. 13, 2007

(54) Motorized garbage can and automatic lid opener

(76) Inventor: Kristie Lynn Wilson, Marysville, KS (US)

Correspondence Address: Kris Wilson, 1587 12th Road, Marysville, KS, 66508, US

(21) Appl. No.: 11/372,402

(22) Filed: Mar. 10, 2006

(51) Int. Cl. B60K 1/00

(52) U.S. Cl. 180/65.1

(57) ABSTRACT

A remote controlled motorized garbage can that is capable of transferring material to the intended designation, in conjunction, an automatic lid opener apparatus to facilitate in the dispersing of material and the lid comprising a lock and sensor mechanism to prevent personal, financial and other such information readily accessible for unlawful inclinations. To transfer the container by a remote control, rather than manual exertion, provides an efficient, convenient and permits accessibility, in consideration, to almost all individuals of physical ability.

### FEDERALLY SPONSORED RESEARCH

Not Applicable

### SEQUENCE LISTINGS OR PROGRAM

Not Applicable

### BACKGROUND OF THE INVENTION

1. Field of Invention

The present invention generally relates to garbage cans, specifically to a motorized garbage can having a rechargeable battery and remote control, but also consisting of automatic lid opener, in addition, a security mechanism to prevent spills and personal or financial information readily accessible for unlawful predispositions.

2. Prior Art

Trash disposal or sanitation services commonly supply customers with trash receptacles or garbage cans to disperse of unwanted material. Commonly, garbage cans are manufactured with wheels to accommodate customers with handling these containers to the edge of the driveway or to the curbside for disposal.

Garbage cans are assembled and fashioned in various size, shape, composition and color with beneficial modifications attached such as, wheels, lids, legs, handles and weight. These modifications are constructed to alleviate the tiresome routine involved with transporting garbage cans to the curbside and to the prevention of tipping or spilling of the contents. However, the previous alterations are mostly advantageous to individuals without physical difficulties. Not to mention, these adjustments still require an individual to manually perform this repetitive process of transporting these containers to the curbside for disposal.

Another problem with garbage cans is the convenience of dishonest individuals to gain access to the contents within the container. Therefore, relinquishing personal or financial information to be used in a manner of criminal predispositions, such as identity theft. Several solutions have been devised to secure the lid on garbage cans, however, these devices lack an efficient and convenient method, in regards to a remote control security mechanism, that provides not only accessibility and efficiency to the trash disposal service provider, but also prevents easy accessibility to unwanted individuals to the contents within the container, for example, in U.S. Pat. No. 5,938,250 to Onken (1999) discloses a lock for a retractable U-shaped handle. However, this lock prohibits the trash disposal service from access, convenience and efficiency to disposing of the contents within the container and the lock is practical to containers uncommonly used for residential curbside disposal. U.S. Pat. No. 6,390,522 to Rucker (2002) discloses a lid lock consisting of a tubular structure shaped to secure the lid as the device extends over the top of the more customary garbage can. However, this lock allows access to unwanted individuals to open the lid from the container, but nevertheless previous garbage cans heretofore known suffer from a number of disadvantages:

(a) The present garbage cans require in some manner to physically haul these containers, that results an individual to routinely drag these containers to the curb. However, this task becomes laborious to perform with a physical difficulty, such as paralysis.

(b) The present procedure requires individuals to manually perform this customary routine during unfavorable weather conditions.

(c) The present garbage cans requires individuals to physically return back to the can to move the container to each designation, however, the constant act becomes more tedious to perform with the labor of yard maintenance, such as raking leaves or gathering fallen tree branches.

(d) The present procedure, with curbside trash disposal, still maintains the burdensome process of an individual to physically perform this repetitive task.

(e) The present garbage cans or trash receptacles lack of a sufficient lid or cover to securing the contents within the garbage can, that is not only efficient to open for the owner and the trash disposal service provider, but also to prevent personal or financial information placed into the possession of dishonest individuals to be used in a criminal manner, such as identity theft predicaments.

### Objects and Advantages

Accordingly, several objects and advantages of the present invention are:

(a) to provide not only the accessibility and enhance capability but also accommodate to the independence of individual's having a physical difficulty, such as paralysis, as this ritualistic task is performed;

(b) to provide a motorized container or cart which greatly reduces the hassle and exertion that is accustomed to curbside disposal, rather then manually handling these containers;

(c) to provide a motor within the container in which sufficient amount of weight is equipped to prevent the garbage can capsizing or spilling the contents within;

(d) to provide a garbage can in which to safeguard individuals from unfavorable weather conditions and potential threats or intrusions as one physically performs this task;

(e) to provide a garbage can which conveniently propels the remote controlled container to return to the appropriate location while the user is either positioned in the vehicle, such as one arriving home, or to remain in the house, maintaining contact with present engagements;

(f) to provide an efficient garbage can that lightens yard maintenance, such as raking leaves or gathering tree branches, rather than physically returning to the container to move it along;

(g) to provide a mechanical lid apparatus which operates to permit the opening or closing of the lid without manual performance, thereby, reducing handling of the container and exposing an individual to potential germs or bacteria located on the garbage can;

(h) to provide a lid fastening device on the garbage can which allows capability to be efficient and convenient in securing the container for not only the user but also readily accessible to the disposal service provider to unlock, rather then handling other types of lock contrivances;

(i) to provide a sensory mechanism on the remote control in which a warning device is constructed so the owner is alerted of tampering from unwanted individuals for criminal inclinations;

(j) to provide a lid fastening device on the container in which the lid is less susceptible to be blown off from the wind or knocked off due to animals.

Further objects and advantages are to provide a garbage can which will be used easily and conveniently to operate and lift, without damage to the motor and other components, which is simple to produce and relative inexpensive to manufacture, which can be applied to various disposal containers, which will consist of a remote controlled lid opener accessible to the appropriate individuals but also provide a durable security mechanism to prevent unwanted individuals from gaining access to the contents within the container. Still further objects and advantages will become apparent from a consideration of the ensuing description and drawings.

### SUMMARY

In accordance with the present invention, a motorized garbage can that is capable of transferring discarded material to the intended designation by remote control, either consisting of material or of empty space, which, in addition to reducing the manual labor of hauling garbage cans to the curbside, but also assist in the reduction of the container being overturned, due to the weight of the motor. Furthermore, an automatic lid opener apparatus provided in accordance with the present invention to facilitate in the dispersing of unwanted material. In addition, a security mechanism to prevent personal, financial and other such information readily accessible for unlawful inclinations. More particularly, a lock operated by a wireless remote control but also an additional locking mechanism, such as a combination lock, located on the container.

### DRAWINGS—FIGURES

FIG. 1 is a perspective view of a motorized garbage can with the secondary base according to one preferred embodiment of the present invention;

FIG. 2 is a side view of a motorized garbage can with an additional wheel for added balance according to an alternative embodiment of the present invention;

FIG. 3 is a side view of the preferred lid on a garbage can with the automatic lid in the close position;

FIG. 4A illustrates a cut-away view to show the lid (security) lock mechanism shown in FIG. 3 in a closed position relative to the center of the front of the lid on the container;

FIG. 4B illustrates an enlarged rear perspective view of the security lock mechanism shown in FIG. 3 in a somewhat closed locked position relative to the center of the lid, in which hidden areas are depicted by broken lines;

FIG. 5 is a perspective view of a wireless remote control to one preferred embodiment of the present invention;

FIG. 6 illustrates an enlarged brake mechanism from the side view perspective, including a sliding cover with a clip attached, according to an alternative embodiment of the present invention;

FIG. 7 illustrates a side view of a motorized wheelbarrow according to an alternative embodiment of the present invention.

### REFERENCE NUMERALS

| | |
|---|---|
| 10 | Wheel |
| 11 | Base of the Secondary Body |
| 12 | Secondary Body of the Container |
| 13 | Belt Drive |
| 14 | Motor |
| 15 | Battery |
| 16 | Extended Leg |
| 18 | Additional Wheel |
| 20 | Base of the Main Body on Container |
| 22 | Main Body on the Container |
| 24 | Hollow Shaft |
| 26 | Remote Control Holder |
| 27 | Handles |
| 28 | Lid Flap |
| 30 | Sensor |
| 32 | Lid of Container |
| 34 | Rear of the Lid |
| 36 | Topmost Part of the Main Body on Container |
| 38 | Part of the Lock Attached to the Container |
| 40 | Underneath Side of Lid |
| 42 | Part of the Lock Attached to the Lid |
| 58 | Remote Control |
| 60 | Antenna |
| 62 | On/Off Switch |
| 64 | Warning Light |
| 66 | Directional Arrows |
| 68 | Lid Opener/Closer Switch |
| 70 | Lid (Security) Lock Switch |
| 90 | Brake Mechanism |
| 92 | Sliding Cover |
| 94 | Clip |

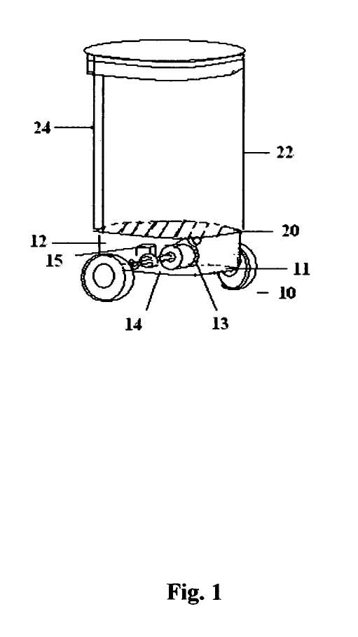

### DETAILED DESCRIPTION—FIGS. 1, 3 AND 5-PREFERRED EMBODIMENT

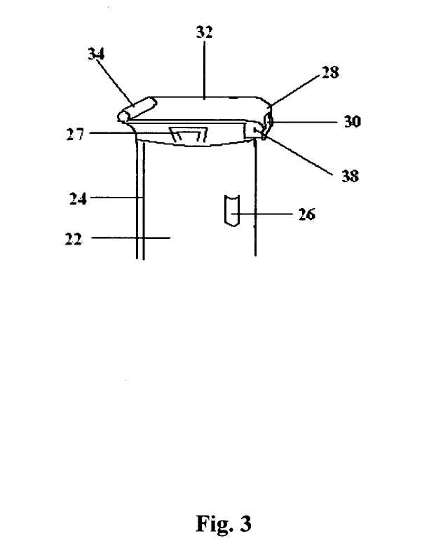

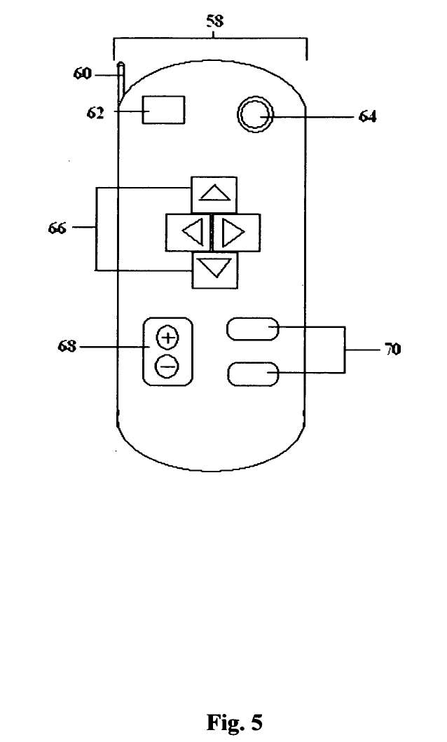

A preferred embodiment of the motorized garbage can, trash receptacle or container of the present invention is illustrated in FIG. 1 (lower portion), FIG. 3 and FIG. 5. The container of the invention includes: a set of wheels 10; a walled and hollowed body that consists of an upper or main 22 and a lower or secondary 12 compartment; a motor 14 and of sufficient components for conveying rotational energy, such as a battery 15, a belt drive 13, gears, drive shaft, pulleys, etc; a lid 32 (FIG. 3) and a remote control 58 (FIG. 5). In the preferred embodiment, the four pivotal wheels 10 (only two wheels 10 are shown in FIG. 1) are assembled with a wide tread and attached to a device connecting two symmetrical wheels, such as an axle. However, the wheels 10 can be any such device used to aid or produce a rolling motion or movement, consisting of various width, composition, size and having one or more wheels 10 that are perpendicular, angled or such position. The axle is located adjacent or throughout the base of the secondary body 11 on the container. The walled, hollowed cylindrical or rectangular secondary body 12 is the lower compartment, area, division or part on the container that retains the motor 14, the belt drive 13, the battery 15 and the complementary parts, such as the gears, pulleys, drive shaft, etc. On the exterior of the secondary body 12 is an aperture, preferably with a removable or sliding cover that allows access to the area within the secondary body 12. The motor 14 and all other accompanying parts are situated below the platform, bottom or base of the main body 20 on the container. The base of the main body 20 can consist of a removable bottom to provide accessibility to the area within the secondary body 12. The region above the base of the main body 20 is the main body 22 of the container that is the receptacle compartment. Located upright along the interior wall of the main body 22 is a hollow shaft 24 for the placement of the electrical wires. Situated on the exterior of the main body 22 is a remote control holder 26, to store the remote control. Placed on the container are handles 27 for gripping thereof.

However, the remote control holder 26 is not limited in location, such as in the garage on a wall or without a holder. The hollow shaft 24 is not confined to the interior area of the container, but placed on the exterior of the container or, rather than a shaft, an interior wall that runs along the wall of the main body 22, thereby, providing space for the wires. The container does not necessarily separate into two sections but, rather the motor 14 is situated underneath, along the side or placed onto an (adjustable) container cart, whereby, the user places or attaches the container onto a separate motorized unit to transfer the garbage can. The motor 14 can consist of various forms, features, parts, etc. To produce the movement of the container, the container can consist of a feature capable of using energy to produce the movement, such as: a mechanism which induces electric charges by such mechanical power; a mechanism that is generated by mechanically moving conductors through one or more magnetic field(s) or converts mechanical energy into electrical energy or vice versa, such as motors and generators; a device which produces an electromotive force through electrochemical action, such as a battery; a device that produces electromotive force through the action of heat; fueled by gasoline or gas-operated; a device that produces electromotive force by the action of light, such as solar powered; and a device that produces electromotive force by a certain source of physical pressure, such as a crystal. A mechanism supplied with power or a source of power, that is operated by electricity, such as a “power” garbage can, container or trash receptacle or served by an auxiliary that reduces the physical effort of the operation will, in addition, apply to the movement of the container.

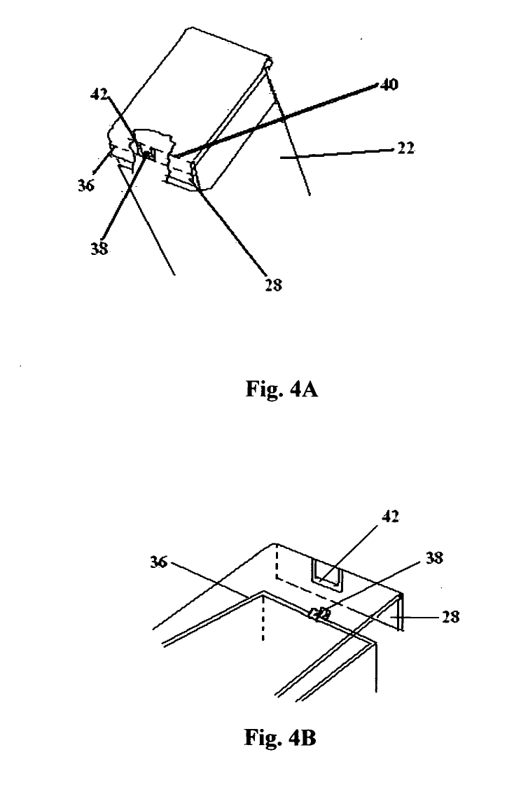

In the preferred embodiment, attached to the topmost part of the main body 36 is the lid 32 on the container (FIG. 3), preferably with a rectangular shape, attached to a hinged or pivotal apparatus, by automation, which is located at the rear of the lid 34. Towards the front of the lid, the lid 32 extends over the topmost part of the main body 36, known as the lid flap 28. Located on the lid flap 28 is a sensor mechanism 30. Magnetic lining adheres to the topmost part of the main body 36 and the underneath side of the lid 40 (FIG. 4A and 4B) to latch the lid 32 to the container. A lid locking mechanism is located on both the lid 32 and container to secure the lid 32, therefore, preventing unwanted individuals and animals to the contents within the container. A part of the lock attached to the lid 42, such as a U-shaped handle and a part of the lock attached to the container 38, such as a two part unit that closes when locked, once the handle is between the unit. The part of the lock attached to the container 38 contains a sensor mechanism to alert the user, either when the two part unit is locked or unlocked.

However, in other embodiments, the lid 32 can consist of a removable cover, thereby, opposing an attachment that allows a swinging motion. The lid 32 can consist of a device that enables the lid 32 to remain closed or no device at all, rather than the magnetic lining. The lid 32 can consist of various size, shape and color, such as circular, rather than rectangular.

In the preferred embodiment, the remote control 58 (FIG. 5) operates the movement of the container. The remote control 58 is equipped with a device to send or receive electromagnetic waves or an antenna 60 and the basic knobs, buttons, or switches to control the movement of the container. The switches include: a on/off switch 62; a warning light 64 that flashes to indicate the lid 32 is unlocked; a set of directional arrows 64 to operate the motion of the container, whereby, pressing, for example, the up arrow and the right arrow will move the container in a right upward motion; a switch to open and close 68 the lid 32; and a switch to engage the lid lock 70 mechanism, to either turn on or turn off the security mechanism.

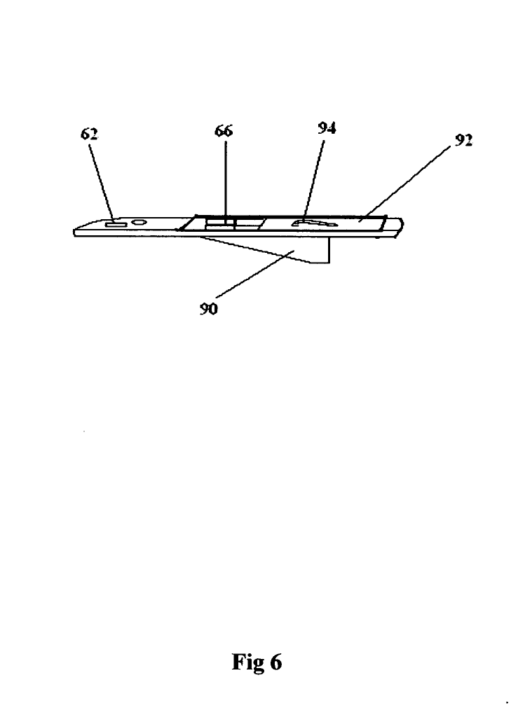

However, the remote control 58 can consist of various dimensions, preferably, pocket-sized. The switches can consist of various shapes, such as a joystick device. The switch to open and close 68 the lid 32 can consist of a delayed timer to close the lid 32, rather than a switch to press. Located on the posterior of the remote control 68 depicts a clip (FIG. 6) to fasten to the user's clothing, however, any device suitable to carry without gripping such as a string, rope or necklace to be placed around, for example, the neck. A brake mechanism (FIG. 6), resembling, for example, a trigger device that is positioned on the posterior of the remote control 58. In other embodiments, the remote control 58 can contain additional switches, including, but not limited to; a switch to elevate the container and then tilts or empties the container, or a switch that enables the wheels 10 to convert to a full tractor tread, therefore, capable to adjust to steps or stairs. Nevertheless, the motorized container equipped with wheels 10 is capable of reducing the manual labor, of dragging garbage cans to the curbside, with steps or stairs, by the user embracing the container with one hand and operating the remote control 58 in the other hand, to ease the container down the steps.

Operation--FIGS. 1, 3, 4 A, 4 B, 5 and 6

The manner of utilizing the motorized garbage can is operable from the wireless remote control 58 (FIG. 5), provided with a battery. The remote control 58 commands the movement of the container, with each motion corresponding to the appropriate switch, such as the open/close switch 68 to control the lid 32 to either open, allowing trash and the like therein to be placed into the receptacle area or to close the lid 32, thereby, containing the material. The mechanical movement of the container from one designation to another or the activity of the lid 32 by electrical force is functional from the configuration of the motor 14 (FIG. 1); such as consisting of pairs of motors, synchros, which provide the ability for the magnetic reaction to the current, in conjunction with the accompanying components. Attached to the motor 14 is the rechargeable battery 15, to furnish a current, whereby, the connecting wires are ran upright through the base of the main body 20 and into the hollow shaft 24 of the main body 22 until reaching the rear 34 and front of the lid 28 (FIG. 3, 4A and 4B). The sensor mechanism 30 is responsive to changes in the quantity to be measured, such as the position of the lock mechanism 38, provided with a transducer to convert such measurement into electrical signals to the remote control 58, however, any such device to respond to such measurement, whether the device acts as both the sensor and transducer or separate devices are used are applicable.

Therefore, to control a certain function on the container, press the corresponding switch such as: to regulate the power of the container to be turned on or off, the corresponding switch is the on/off switch 62; to operate the movement of the container, the corresponding switches are the directional arrows 66; to control the lid 32 to open or close, the corresponding switch is the lid opener/closer switch 68; to command the action of the lid lock, the corresponding switch is the lid lock switch 70. The action of the lid lock 70 is govern by a sensor mechanism 30 that is responsive to the position of the lock, thereby, signaling the warning light 64 to alert the user whether the lid 32 is locked or unlocked. However, the remote control 58 is not limited to the previously mentioned switches, for example, a switch for braking (FIG. 6), a switch to elevate the container, for tipping the contents, or a switch to convert the container to a full tractor tread.

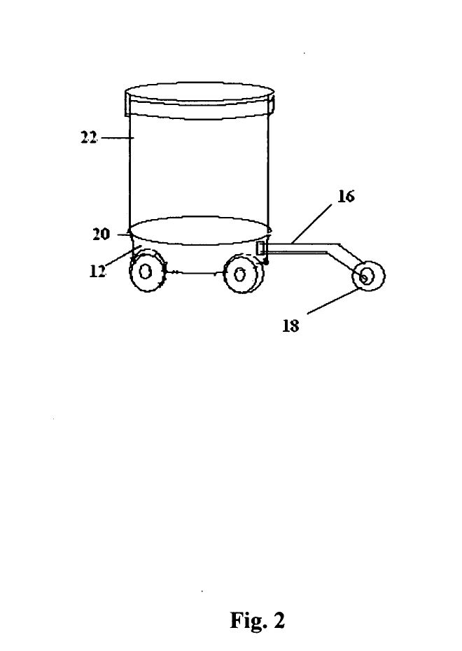

### FIGS. 2, 6 and 7—Alternative Embodiments

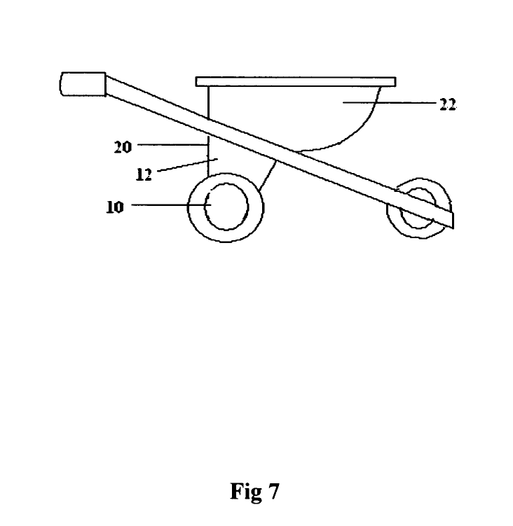

Additional embodiments are shown in FIGS. 2, 6 and 7; the second figure illustrates an extended leg, attached to the container, and connected to an additional wheel to provide added stability in retaining the container an upright position. In FIG. 6 the remote control demonstrates another option, the brake mechanism, to provide more control in the movement of the container. Since, the brake mechanism is located on the posterior of the remote control, another additional feature, the clip is located on the anterior, rather than the posterior. The clip is attached to the sliding cover, which slides over the directional arrows, the lid opener/closer and the lid lock switches, therefore, allowing the user to attach the clip to an article of clothing or around a body part. In FIG. 7 the illustration is a motorized wheelbarrow with the motor located in the secondary body.

### Additional Embodiments

There are various contingencies with regard to the relative disposition of the parts and features but also the dimensions, composition, quantity, color, etc. in the production of the present invention, such as the following features; the wheels, the body of the container, the motor, the lid, the remote control and the wheelbarrow. The quantity of wheels assembled to provide the necessary stability, as illustrated in FIG. 2, which presents an extended leg attached to an additional wheel demonstrates various possibilities. Therefore, any such device and quantity used to provide the movement and stability of the container, regardless of location, composition, design, an extended leg, tractor tread, etc. is the objective.

The practicality of the container is to retain the material that is placed within thereof. The design of the invention is to occupy two compartments, one to serve as the receptacle area and the other compartment to maintain the motor. However, the motor is not limited in location. The motor is able to reside underneath the container or on a separate (adjustable) motorized container cart or bin, in which the garbage can is placed, securely, above the cart. The application of the motor is to reduce, if not eliminate, the manual labor of dragging the container to the intended designation. Therefore, to produce the movement of the container, the mechanism is not limited to a motor but any means of energy to provide movement, such as: a mechanism which induces electric charges by mechanical means; a mechanism that is generated by mechanically moving conductors through one or more magnetic field(s) or converts mechanical energy into electrical energy or vice versa, such as motors and generators; a device which produces an electromotive force through electrochemical action, such as a battery; a device that produces electromotive force through the action of heat; fueled by gasoline or gas-operated a device that produces electromotive force by the action of light, such as solar powered; and a device that produces electromotive force by means of physical pressure, such as a crystal. A mechanism supplied with power or a source of power, that is operated by electricity, a “power” garbage can, or trash receptacle or served by an auxiliary that reduces the physical effort of the operation will, in addition, be applicable to the intention of the invention.

The fundamental purpose of the lid is to secure the contents within the container, therefore, any device that is able to secure the lid to the body of the container, rather than the magnetic lining is applicable. Nevertheless, the primary intention in the development of the lid is to reduce the hassle of handling the lid, by automation, and a lock mechanism equipped with a sensor device to alert the attention of the user to a potential security threat. Therefore, the design to these devices are acceptable in the function or appearance to any such contrivances or contraptions.

The design of the remote control is to manage the workings of the container and suitable to transport, for the user. Therefore, any such feature on the container that can be operated by the remote control or constructed with the intent to be controlled by a hand held device is a logical embodiment, such as a switch to brake or decelerate the container, or a clip to allow attachment to the user.

The conception of the motorized garbage can is to reduce the exertion, if not eliminate, the manual labor of dragging containers devised to transport discarded material or objects either a loaded or unloaded container to each designation. Therefore, such a description can extend and apply to the wheelbarrow, such as a motorized wheelbarrow.

Advantages

From the description above, a number of advantages of my motorized garbage can or trash receptacle become evident:

(a) to provide not only the accessibility and enhance capability but also accommodate to the independence of individual's having a physical difficulty, such as paralysis, as this ritualistic task is performed;

(b) to provide a motorized container which greatly reduces the hassle and exertion that is accustomed to curbside disposal, rather than manually handling these containers;

(c) to provide a motor within the container in which sufficient amount of weight is equipped to prevent the garbage can capsizing or spilling the contents within;

(d) to provide a garbage can in which to safeguard individuals from unfavorable weather conditions and potential threats or intrusions as one physically performs this task;

(e) to provide a garbage can which conveniently propels the remote controlled container to return to the appropriate location while the user is either positioned in the vehicle, such as one arriving home, or to remain in the house, maintaining contact with present engagements;

(f) to provide an efficient garbage can that lightens yard maintenance, such as raking leaves or gathering tree branches, rather than physically returning to the container to move it along;

(g) to provide a mechanical lid apparatus which operates to permit the opening or closing of the lid without manual performance, thereby, reducing handling of the container and exposing an individual to potential germs or bacteria located on the garbage can;

(h) to provide a lid fastening device on the garbage can which allows capability to be efficient and convenient in securing the container for not only the user but also readily accessible to the disposal service provider to unlock, rather than handling other types of lock contrivances;

(i) to provide a sensory mechanism on the remote control in which a warning device is constructed so the owner is alerted of tampering from unwanted individuals for criminal inclinations;

(j) to provide a lid fastening device on the container in which the lid is less susceptible to be blown off from the wind or knocked off due to animals.

Conclusion, Ramifications and Scope

Accordingly, the reader will observe that the motorized device of the invention enables individuals, with a ritualistic activity, to an exceedingly efficient, remote controlled, security mechanism that safeguards individuals and permits accessibility, without the manual exertion, in consideration to almost all persons of physical ability.

Furthermore, the motorized garbage container can consist of additional alternatives in that:
rather than, the preferred “master” remote control to be used by the trash disposal service provider, a glove or a sensor positioned on the arm lift of the garbage truck is applied. The glove, for example, may have a second inner lining, thereby, placing a battery within the interior, located above the palm of the hand. The wires will run from the battery to the tip of a finger, allowing the individual to promptly swipe the sensor on the lid of the container, thereby, automatically opening the lid;
the wheelbarrow includes an extending arm to lift the desired object from the surface. Additional feature on the wheelbarrow may consist of a sliding base or elevating one end of the container, therefore, allowing the contents to empty;
the remote control includes buttons or switches consisting of numbers that are used to provide the ability to insert the numbers for the password or a combination to the lid lock, for such locking contrivances.

While my application contains many specificities, these should not be construed as limitations on the scope of the invention, but rather as an exemplification of one preferred embodiment thereof. Many other variations are possible. For example, the quantity of wheels are not limited in number, or size, shape, color, degree or angle, etc.; the body of the container may consist of various shape, color, dimensions, composition or have one or more separate compartments, etc.; the remote control holder is not restricted in location, dimensions, composition, etc, or no holder at all; the hollow shaft can consist of various locations on the exterior of the container, or rather than a shaft, a second interior wall around the inner surface of the container or no shaft or interior wall at all; the aperture is not restricted in the vicinity of the exterior on the secondary body, but positioned underneath the base of the secondary body, the aperture can consist of a cover or without one or of various sizes, etc.; the magnetic lining may adhere to other locations, such as the lid flap, the magnetic lining can consist of various dimensions, location, composition, length, color, etc., or no lining at all; the sensor mechanism is not confined to any such location, dimensions, composition, the measured quantity of change, etc., or no sensor at all; the lid locking mechanism is not restricted to any such structure, composition, dimensions, location, etc., or no locking device at all; the extended leg can consist of various location on the exterior of the container and attached to an additional wheel. The additional wheel can consist of various sizes, such as the same or of smaller size compared to the wheels that are adjacent to the base of the secondary body; the lid has an additional lock, such as a combination lock; the remote control is not restrained to the preferred switches, but to include such switches as to decelerate the container, a switch to elevate and then tilt the container, a switch to slide the base of the container, a detection device to locate the remote control, a set of numbers, the switch to open and close the lid of the container may consist of separate switches or the lid may close after a predetermined amount of time; the lid on the container can consist of various devices to connect to the container or no attachment at all. Thus, the scope of the invention should be determined not by the embodiments illustrated, but by the appended claims and their legal equivalents.

I claim:

1. A self-propelled container, comprising;
a) a body having rotatable wheels mounted thereunder for enabling said body to roll along a surface,
b) a motor mounted in said body for producing rotational energy, and
c) means for conveying controllably rotational energy from said motor to at least one of said wheels,
Whereby said body will be self-propelled along said surface.

2. The container of claim 1 wherein said body has a lid.

3. The container of claim 2 wherein said lid contains means for causing it to lock to the body.

4. The container of claim 3 wherein said lid contains means for said sensor mechanism that is responsive in said changes of said lock mechanism.

5. The container of claim 1 wherein said body contains means for said rotational energy that is controllable by said remote access.

6. The container of claim 1 wherein said motor mounted in said body includes a said cart and said container is placed onto said cart.
